(19) United States
(12) Patent Application Publication
(10) Pub. No.: US 2012/0137338 A1
(43) Pub. Date: May 31, 2012

(54) DECODER VESA MOUNTING ASSEMBLY

(75) Inventors: Joshua Driggs, Cedar Park, TX (US); Paul Robert Bryson, Austin, TX (US); Michael Braithwaite, Austin, TX (US)

(73) Assignee: CLEARONE COMMUNICATIONS, INC., Salt Lake City, UT (US)

(21) Appl. No.: 13/389,258

(22) PCT Filed: Aug. 5, 2010
(86) PCT No.: PCT/US2010/044492

§ 371 Date: Feb. 6, 2012

Related U.S. Application Data
(60) Provisional application No. 61/232,088, filed on Aug. 7, 2009.

(51) Int. Cl. H04N 21/418; H04N 21/63; H04N 21/414

(52) U.S. Cl. 725/110

(57) ABSTRACT

A decoder VESA mounting assembly includes a housing that further includes an internal printed circuit board (PCB) mounted in an inverted orientation and where the PCB contains circuitry to receive the audio signal, the video signal, and the control command signals from the network source. The PCB processes and transmits the audio signal, the video signal, and the control command signal to the display device. The housing is compatible with the VESA 100×100 mounting standard. The assembly further includes network connections. The assembly includes power connections. The assembly includes a video out connection. The assembly additionally includes an audio out connection. The assembly includes a control command input connection and output connection.

The present application is a National Phase filing under 35 U.S.C. §371 of International Application No. PCT/US2010/044492, filed on Aug. 5, 2010, which claims the benefit of U.S. Provisional Patent Application Ser. No. 61/232,088, filed Aug. 7, 2009, expired, each of which is incorporated by reference for all purposes into this specification, this application.

### TECHNICAL FIELD

The present disclosure generally relates to mounting assemblies. More specifically, the present disclosure relates to a decoder VESA compatible Mounting assembly.

### BACKGROUND

NetStreams IP-Based and IP-Controlled systems, designed for commercial and recreational use, handle virtually any number of digital or analog sources and deliver compressed and uncompressed content, including high definition audio and video, to virtually an unlimited number of zones. Most importantly, any zones playing the same source will be perfectly synchronized, to less than 1 millisecond. By combining content and control signals in one data stream, NetStreams systems offer new levels of simplicity, reliability, and expandability, benefiting both integrators and end users with lower costs for installation, set-up and support.

One of the products produced by NetStreams is the ViewLinX IP Video Decoder. The ViewLinX functions as a TCP/IP based audio/video decoder and controller on a DigiLinX system. Each ViewLinX is capable of decoding, in real-time, high definition or standard definition video (with audio) for a display device. In addition to providing audio and video to a display device, ViewLinX also controls the display device using IR or RS-232 control command signals and provides two contact closures. All the audio, video, and control data are carried to the ViewLinX over the same Ethernet cable.

Each ViewLinX contains the hardware and software to render audio, video, and control signals for a display. This infrastructure gives the ViewLinX several advantages over traditional architectures. Each ViewLinX can be independently configured for signal type: component, composite, S-video, or VGA allowing multiple signal types to be used throughout a system. All the audio, video, and control commands are carried to the ViewLinX over the single network connection (CAT5/5e/6 or Fiber), reducing the number of cables.

A ViewLinX is a High Definition and Standard Definition Video Decoder. To provide stunning real-time video imagery, ViewLinX uses NetStreams PerfectPixel technology. This patent-pending technology ensures reliable delivery of video data and eliminates dropped packets. Using TCP/IP to deliver the video data avoids problems with signal degradation for long cable runs. A virtually unlimited number of ViewLinX's can be supported in a DigiLinX system and ViewLinX can be added to a system at any time.

In addition to providing video services, ViewLinX also provides audio to the display or separate multichannel receiver with a built-in Audio Encoder/Decoder. Built into the ViewLinX are analog and digital line level outs that connect to the audio inputs on a display or receiver. Audio from the display can be encoded and made available to other zones in the home. This is ideal for streaming audio from displays with cable/satellite boxes located at the display.

Using a 1U, ½ rack width chassis, ViewLinX can be mounted directly to a wall or table using the included mounting plates. Two ViewLinX can be mounted side by side using a NetStreams Rack mount Binding plate (sold separately) or it can be left freestanding.

One problem with the current ViewLinX is the size and shape of the assembly, as it does not readily lend itself to use in all situations. Thus, there is a need for an improved form factor to allow the extended use in a variety of situations that include, for example, sports bars or airports or other locations where it is not feasible or aesthetically pleasing to install a device with a large form factor.

NetStreams patented StreamNet technology provides the backbone for DigiLinX. StreamNet technology and ensures that audio and video between all zones are within 500 microseconds of each other, StreamNet Connected devices work seamlessly together, and can be updated in the future as new features become available. The StreamNet technology is better described in the following patents: U.S. Pat. No. 7,643,894, and patent applications: U.S. application Ser. Nos. 11/467,340, 11/960,401, 12/015,385, 12/418,267, and 12/472,976, all of which are incorporated by reference for all purposes into this specification.

### SUMMARY OF INVENTION

This disclosure describes a decoder VESA mounting assembly 10 that receives the audio, video, and control command signals from a network source 60 through a network 62 and processes and transmits those signals to a display device 40 and/or a separate audio playback system 68. The disclosed decoder mounting assembly 10 includes a housing 12 that further includes an internal printed circuit board (PCB) 15 mounted in an inverted orientation and where the PCB 15 contains circuitry to receive the audio signal, the video signal, and the control command signals from the network source 60. The PCB 15 additionally processes and transmits the audio signal, the video signal, and the control command signal to the display device 40. The housing 12 is compatible with the VESA 100×100 mounting standard. The assembly 10 further includes one or more network connections 18a and 18b that transfer the audio signal, the video signal, and the control command signals from a network source 60 through a network 62, where the network connections couple to the PCB 15. In addition, the assembly 10 includes one or more power connections 16a and 16b, where the power connections couple to the PCB 15. The assembly 10 may further include a video out connection 20 that couples to the PCB 15 and provides the video signal to the display device 40. Additionally, the assembly 10 can include an audio out connection 26 that couples to the PCB 15 and provides the audio signal to the display device 40 or to a separate audio playback system 68. The assembly 10 may further include a control command input connection 24 and output connection 22 that couples to the PCB 15 and that provides control command signals to and from the display device 40 and or the separate audio playback system 68 and the source 60 of the video and audio signals.

The disclosed assembly can further provide that the network connection 18a and 18b uses a TCP/IP LAN network 62. In addition, the assembly 10 may optionally couple to a wall mounted bracket 30. The assembly 10 can also provide that the control command input connection 24 and output connection 22 includes an integrated connection.

### BRIEF DESCRIPTION OF DRAWINGS

To further aid in understanding the disclosure, the attached drawings help illustrate specific features of the disclosure and the following is a brief description of the attached drawings:

FIG. 1 discloses a perspective view of a particular embodiment of the disclosed invention;

FIG. 2 discloses a back panel view of the embodiment of the disclosed invention;

FIG. 3 discloses a front panel view of the embodiment of the disclosed invention;

FIG. 4 discloses a bottom panel view of the embodiment of the disclosed invention;

FIG. 5 illustrates an embodiment of the disclosed invention being wall mounted with a wall mount bracket;

FIG. 6 illustrates an embodiment of the disclosed invention being mounted in-between a VESA 100×100 Mounting bracket and a display device; and

FIG. 7 illustrates an embodiment of the invention in use in a network environment.

### DETAILED DESCRIPTION

The present disclosure describes a Decoder VESA Mounting assembly. This disclosure describes numerous specific details in order to provide a thorough understanding of the present invention. One skilled in the art will appreciate that one may practice the present invention without these specific details. Additionally, this disclosure does not describe some well known items in detail in order not to obscure the present invention.

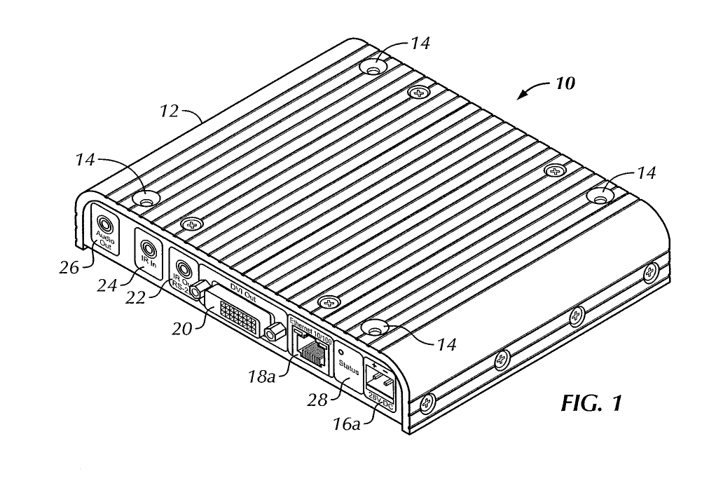

FIG. 1 discloses a perspective view of a particular embodiment of the invention. The Decoder VESA Mounting assembly 10 improves upon the previously described comprises ViewLinX system with a number of novel features. The assembly includes a housing 12 where one embodiment of the housing 12 includes the following features: unpainted sheet metal that is formed as a single extruded metal component with symmetrical countersunk holes where the extrusion has built-in guide points for the machining process. One embodiment of the disclosed invention includes the housing 12 having dimensions that are approximately 5.75″×4.6″×1″. One skilled in the art will appreciate that other dimensions of the housing are possible.

The housing 12 in an embodiment can be a single symmetrical piece of sheet metal part with simplified bend operations. The housing 12 can use sheet metal screws with no pretapped holes. The housing 12 can also be fabricated so as to not use a metal faceplate, so no laser-etching is required. Since the housing 12 uses extruded sheet metal, the housing need not contain any custom injection molded plastic. In addition, the use of sheet metal in an embodiment of the disclosed invention allows the assembly 10 to easily meet EMI regulations. One embodiment of the claimed invention has one single, wrap-around label for the housing 12, so no silk-screening directly on the housing 12 is required. Finally, the housing 12 can include four screw holes 14 that are spaced to be compatible with the VESA 100×100 mounting standard.

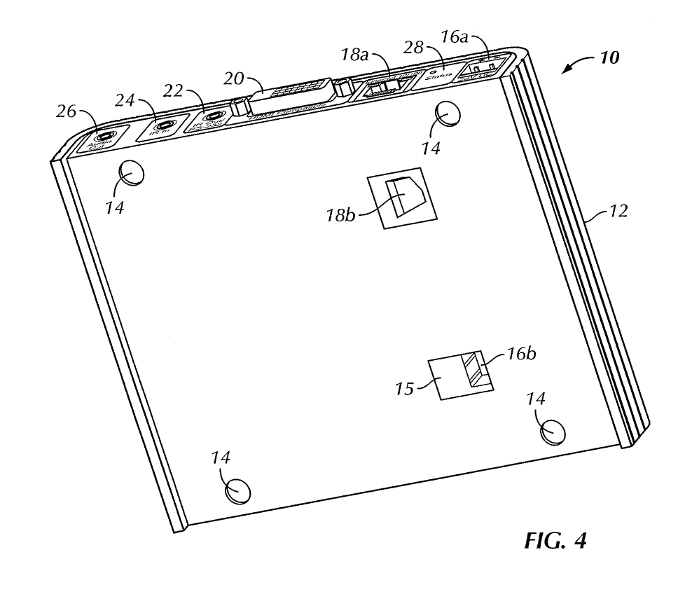

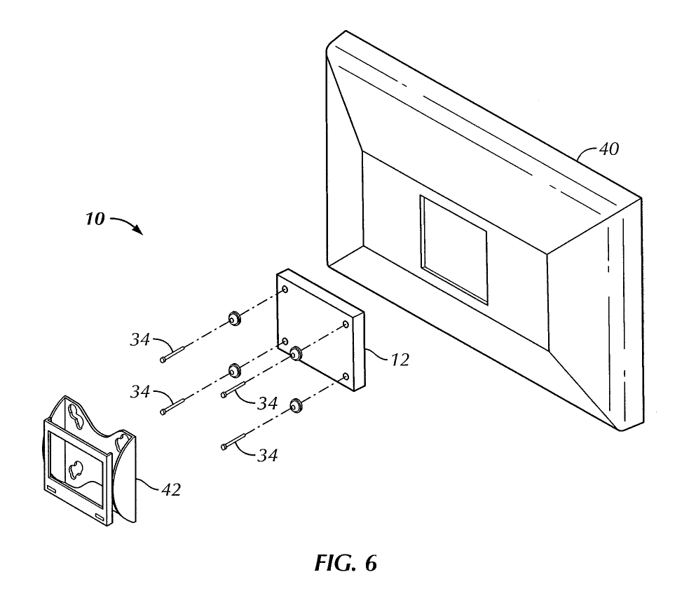

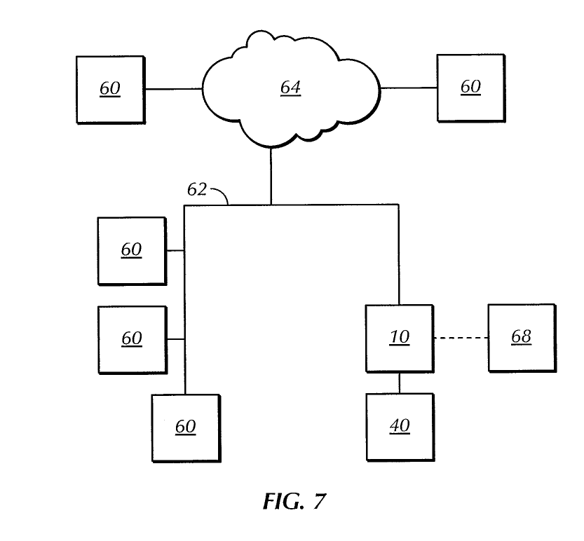

Inside the housing 12 is an internal printed circuit board (PCB) 15 (see FIG. 4) mounted in an inverted orientation and where the PCB contains circuitry to receive the audio signal, the video signal, and the control command signals from the network source 60 (see FIG. 7). The PCB 15 additionally processes and transmits the audio signal, the video signal, and the control command signal to the display device 40 (see FIG. 6). One skilled in the art will appreciate that the PCB 15 can comprise various types of processors, transceivers, digital signal processors (DSPs), and the like that can be used in transmitting, receiving, an processing both compressed and uncompressed audio signals, video signals, and control command signals to and from a network source 60 through a network 62 to a display device 40.

Additionally, the assembly 10 may include a power connection 16a that couples to the PCB 15. One embodiment of the disclosed invention uses a DC power connection. The power connection provides sufficient power for the assembly 10 to perform its various functions. One skilled in the art will appreciate that a variety of power options are available in the arts to power an assembly 10 as described in this disclosure.

Further, the assembly 10 can include a network connection 18a that couples to the PCB 15. The network connection 18a receives the audio signal, the video signal, and the control command signals from a network source 60 on a network 62. In addition, the network connection 18a is used to transmit control command signals through a network 62 to a network source 60. One embodiment of the disclosed invention uses StreamNet as the networking standard and protocol. StreamNet is a TCP/IP based LAN Network. One skilled in the art will appreciate that other networking standards and protocols may be used to transfer the audio signal, the video signal, and the control command signals through a network 62 to and from a network source 60.

The assembly 10 further includes a video out connection 20 that couples to the PCB 15 and which provides video to a display device 40 (see FIG. 6). One embodiment of the video out connection 20 uses a DVI with HDMI connector. One skilled in the art will appreciate that the video out connection may use a variety of video connectors and standards such as DVI, HDMI, or VGA. In addition, one skilled in the art will appreciate that various display devices may or may not include internal speakers.

In addition, the assembly 10 can further include an audio out connection 26 that couples to the PCB 15. The audio out connection 26 provides the audio signal to the display device 40 and or to a separate audio playback system 68. One skilled in the arts will appreciate that the audio signal and the audio out connection 26 may use one or more of a number of different types of audio and or connections. For example, if the display device 40 with internal speakers has an HDMI input, then the audio may be transmitted to the display device 40 through the video out connection 20 using the DVI with HDMI connector or a HDMI only connector.

In a further embodiment, the assembly 10 includes a control command input connection 24 and output connection 22 that couples to the PCB 15. The control command input connection 24 and output connection 22 provide control command signals to and from the display device 40 and or the separate audio playback system 68. In addition, the control command input connection 24 and output connection 22 provide control command can signal to and from the network source 60 of the video and audio signals. One embodiment of the disclosed invention uses an Infra Red (IR) input signal as the control command input connection 24. Additionally, one embodiment of the disclosed invention uses an IR output/RS-232 output for the control command output connection 22. Yet another embodiment of the disclosed invention uses a combined input and output connection for the command input connection and output connection. One skilled in the art will appreciate that a number of techniques and communication standards are available to transmit and receive control command signals between the display device 40 and the network source 60 of the video and audio signals.

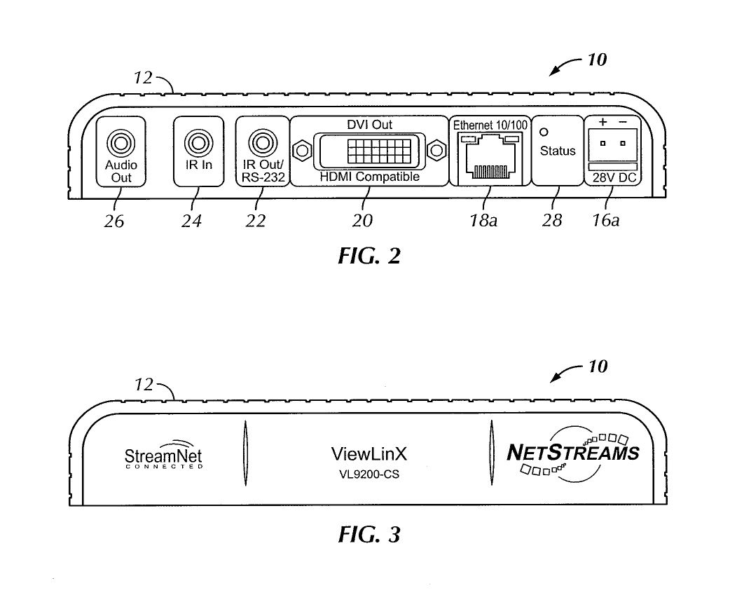

FIG. 2 discloses a back panel view of the assembly 10 that illustrates the following components: the housing 12, the network connection 18a, the power connection 16a, the video out connection 20, the audio out connection 26, the control command input connection 24, the control command output connection 22, and the status LED 28 that provides status information regard the assembly 10. One skilled in the art will appreciate that a variety of status light devices may be used to communicate status information. In addition, a variety of communication formats are available in the arts to provide status information regarding the assembly 10.

FIG. 3 discloses a front panel view of an embodiment of the disclosed invention that illustrates assembly 10 with housing 12.

FIG. 4 discloses a bottom panel view of an embodiment of the invention. This view of assembly 10 again illustrates the following components: the housing 12, PCB 15, the network connection 18a, the power connection 16a, the video out connection 20, the audio out connection 26, the control command input connection 24 and the control command output connection 22, and the four screw holes 14. In addition, one embodiment of the disclosed invention includes a second network connection 18b and a second power connection 16b on the bottom of the housing 12.

This embodiment of the disclosed invention features dual network (18a and 18b) and dual power connections (16a and 16b) that include the second network connection 18b and power connection 16b on the bottom of housing 12. Putting these dual connections on to the assembly 10 allows the disclosed invention to be pre-wired to wall boxes. The inverted mounting of PCB 15 is the trick to gaining both wall-side and rear-panel network and power connections. The inverted PCB 15 also provides plenty of vertical space for tall circuit components.

According to a particular embodiment of the invention, the sheet metal bottom of the housing 12 is designed with overlapping tabs to help with EMI, with each side having four points of ground contact. Additionally, the sheet metal housing can be designed to be easier and cheaper to produce by providing: a symmetrical outline that allows for easy secondary machining; all bends having a clearance around them to allow for easier machining, some without custom bend widths; sheet metal screws holding the extruded lid to the sheet metal, which eliminates the need for a secondary operation to tap all the holes and provides secure ground contact between the extrusion and sheet metal.

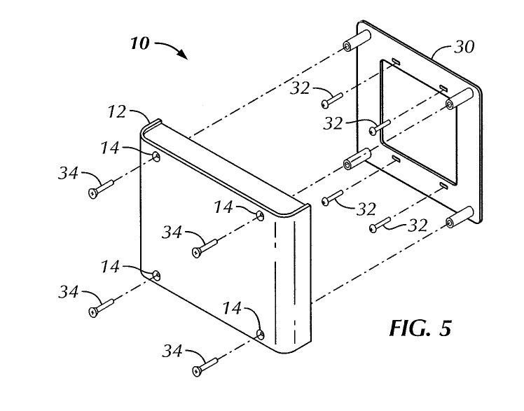

FIG. 5 illustrates an embodiment of the assembly 10 being wall mounted with a wall mounted bracket 30. The wall mounted bracket 30 includes the following features: the wall mounted bracket is designed to be low-cost and easy to install; a single sheet of unbent sheet metal has four large PEM standoffs installed; mounting to any standard 2-gang wall box or directly into dry-wall; and symmetrical design. Screws 32 mount the wall mounted bracket 30 to the dry wall or standard 2-gang wall box. Screws 34 mount the housing of assembly 10 to the wall mount bracketed 30.

The above features allow the assembly 10 to be rotated with the audio, video, control command, network, and power connectors facing Up, Down, Left or Right. The standoffs allow the assembly 10 to be hung on the mount while the screws are installed, eliminating the need to hold the unit up while installing the screw.

The wall mounted bracket 30 also includes the following advantages: the wall-side power connection 16b and network connection 18b are fully accessible though the cutout in the bracket, and the cutout being symmetrical to allow cable access no matter how the assembly 10 is oriented. Another feature of the assembly 10 includes a slim fit against the wall. When connector size and cable bend radius are taken into account, a surface mount box, such as the assembly 10 with right-angle connections, is far slimmer than an in-wall unit with outward facing connectors. For example, if a DVI cable were to be installed into a video connection that was flush with the wall, the DVI cable protrudes an extra 2 inches from the wall, as compared to the bracket of the invention.

FIG. 6 illustrates an embodiment of the assembly 10 being mounted in between a VESA 100×100 Mounting bracket 42 and a display device 40. The mounting holes 14 on the housing 12 are compatible with the VESA 100×100 mounting standard. Thus, the assembly 10 can be mounted directly onto the back of a display that is up to a 32″ display and weighs up to approximately 45 lbs. Mounting the display 40 only requires the use of long M4 screws 34. No additional brackets or adapters are required, as the M4 thread is the standard on all VESA 100×100 displays. The assembly 10 adds approximately 1″ to the thickness of the entire mounted system. One skilled in the art will appreciate that display 40 may include a LCD or OLED monitor, or a display that may comprise older technology, such as a CRT monitor or TV.

FIG. 7 illustrates an embodiment of the invention as used in a network environment. The assembly 10 couples to the display device 40. In addition, the assembly 10 may provide the audio signal to a separate audio playback system 68.

Assembly 10 can couple to a network 62 through network connections 18a or 18b. As previous discussed, one embodiment of the disclosed invention can use StreamNet technology to stream the audio, video, and control command signals over a TCIP/IP LAN.

The network 62 can couple to one or more network sources 60 that reside on the LAN or reside on the Internet 64. The network sources 60 are any type of device that can provide audio, video, and control command signals to the disclosed invention. One skilled in the art will understand that a network source 60 may comprise a cable set top box, digital video recorder, video game console, a computer running media software, or even broadcast or streaming media devices. The disclosed invention is not limited to the type of network source device.

Particular embodiments of the present disclosure describe a decoder VESA mounting assembly 10 that receives the audio, video, and control command signals from a network source 60 through a network 62, and can process and transmit those signals to a display device 40 and or a separate audio playback system 68. The disclosed decoder mounting assembly 10 may include a housing 12 that further includes an internal printed circuit board (PCB) 15 mounted in an inverted orientation and where the PCB 15 contains circuitry to receive the audio signal, the video signal, and the control command signals from the network source 60. The PCB 15 can additionally process and transmit the audio signal, the video signal, and the control command signal to the display device 40. The housing 12 is compatible with the VESA 100×100 mounting standard. The assembly 10 may further include one or more network connections 18a and 18b that transfer the audio signal, the video signal, and the control command signals from a network source 60 through a network 62 where the network connections couple to the PCB 15. In addition, the assembly 10 can include one or more power connections 16a and 16b where the power connections couple to the PCB 15. The assembly 10 further includes a video out connection 20 that couples to the PCB 15 and provides the video signal to the display device 40. The assembly 10 additionally may include an audio out connection 26 that couples to the PCB 15 and provide the audio signal to the display device 40 or to a separate audio playback system 68. Further, the assembly 10 can include a control command input connection 24 and output connection 22 that couples to the PCB 15, and that provides control command signals to and from the display device 40 and/or the separate audio playback system 68 and the source 60 of the video and audio signals.

In the disclosed assembly, the network connection 18a and 18b may use a TCP/IP LAN network 62. In addition, the assembly 10 may optionally couple to a wall mounted bracket 30. The assembly 10 can further provide a control command input connection 24 and output connection 22 that includes an integrated connection.

Other embodiments of the present invention will be apparent to those skilled in the art after considering this disclosure or practicing the disclosed invention. The specification and examples above are exemplary only, with the true scope of the present invention being determined by the following claims.

We claim the following invention:

1. A decoder VESA mounting assembly that receives the audio, video, and control command signals from a network source and processes and transmits those signals to a display device and or a separate audio playback system, comprising:
a housing that comprises an internal printed circuit board (PCB) mounted in an inverted orientation in said housing, said PCB contains circuitry that receives the audio signal, the video signal, and the control command signals from the network source, said PCB processes and transmits the audio signal, the video signal, and the control command signal to the display device, said housing is compatible with the VESA 100×100 mounting standard;
one or more network connections that transfer the audio signal, the video signal, and the control command signals, said network connections couple to said PCB;
one or more power connections, said power connections couple to said PCB;
a video out connection that couples to said PCB and provides the video signal to the display device;
an audio out connection that couples to said PCB and provides the audio signal to the display device or to a separate audio playback system; and
a control command input connection and output connection that couples to said PCB and that provides control command signals to and from the display device and or the separate audio playback system and the source of the video and audio signals.

2. The assembly of claim 1, wherein said network connection uses a TCP/IP LAN network.

3. The assembly of claim 1, wherein said housing may optionally couple to a wall mounted bracket.

4. The assembly of claim 1, wherein said control command input connection and output connection comprising an integrated connection.

5. A method to manufacture a decoder VESA mounting assembly that receives the audio, video, and control command signals from a network source and processes and transmits those signals to a display device and or a separate audio playback system, comprising:
providing a housing that comprises an internal printed circuit board (PCB) mounted in an inverted orientation in said housing, said PCB contains circuitry that receives the audio signal, the video signal, and the control command signals from the network source, said PCB processes and transmits the audio signal, the video signal, and the control command signal to the display device, said housing is compatible with the VESA 100×100 mounting standard;
coupling one or more network connections to said PCB, said network connections transfer the audio signal, the video signal, and the control command signals;
coupling one or more power connections to said PCB;
coupling a video out connection to said PCB, said video out connection provides the video signal to the display device;
coupling an audio out connection to said PCB, said audio out connection provides the audio signal to the display device or to a separate audio playback system; and
coupling a control command input and output connection to said PCB, said control command input connection and output connection provides control command signals to and from the display device and or the separate audio playback system and the source of the video and audio signals.

6. The method of claim 5 wherein said network connection uses a TCP/IP LAN network.

7. The method of claim 5 wherein said housing may optionally couple to a wall mounted bracket.

8. The method of claim 5 wherein said control command input connection and output connection comprising an integrated connection.

9. A method to use a decoder VESA mounting assembly that receives the audio, video, and control command signals from a network source and processes and transmits those signals to a display device and or a separate audio playback system, comprising:
providing a housing that comprises an internal printed circuit board (PCB) mounted in an inverted orientation in said housing, said PCB contains circuitry that receives the audio signal, the video signal, and the control command signals from the network source, said PCB processes and transmits the audio signal, the video signal, and the control command signal to the display device, said housing is compatible with the VESA 100×100 mounting standard;
transferring the audio signal, the video signal, and the control command signals through one or more network connections, said network connections couple to said PCB;
providing power through one or more power connections, said power connections couple to said PCB;
providing the video signal to the display device through a video out connection that couples to said PCB;
providing the audio signal to the display device or to a separate audio playback system through an audio out connection that couples to said PCB; and
providing the control command signals to and from the display device and or the separate audio playback system and the source of the video and audio signals through a control command input connection and a control command output connection that couple to said PCB.

10. The method of claim 9 wherein said network connection uses a TCP/IP LAN network.

11. The method of claim 9 wherein said housing may optionally couple to a wall mounted bracket.

12. The method of claim 9 wherein said control command input connection and output connection comprising an integrated connection.
